(19) United States
(12) Patent Application Publication
(10) Pub. No.: US 2012/0284772 A1
(43) Pub. Date: Nov. 8, 2012

(54) DATA STORAGE DEVICE AUTHENTICATION APPARATUS AND DATA STORAGE DEVICE INCLUDING AUTHENTICATION APPARATUS CONNECTOR

(75) Inventors: Moon-Sang Kwon, Seoul (KR); Bo-Gyeong Kang, Suwon-si (KR); Jung-Wan Ko, Yongin-si (KR); Chang-Woo Sun, Seongnam-si (KR); Byung-Rae Lee, Seoul (KR)

(73) Assignee: SAMSUNG ELECTRONICS CO., LTD., SUWON-SI (KR)

(21) Appl. No.: 13/457,649

(22) Filed: Apr. 27, 2012

(30) Foreign Application Priority Data
May 2, 2011 (KR) 10-2011-0041493

(51) Int. Cl. G06F 21/00

(52) U.S. Cl. 726/2

(57) ABSTRACT

An authentication apparatus includes a data storage unit for storing authentication apparatus identification information, an interface unit for connecting to a host device through a first interface, and an authentication processor that executes an authentication process using the authentication apparatus identification information stored in the data storage unit. The authentication processor executes the authentication process upon receipt of an authentication request signal from the host device through the interface unit, and outputs an authentication response signal including data indicative of a result of the authentication process to the host device via the interface unit. The authentication request signal is for requesting authentication of a data storage device connected to the host device through a second interface.

### CROSS-REFERENCE TO RELATED APPLICATION

A claim of priority under 35 U.S.C. §119 is made to Korean Patent Application No. 10-2011-0041493, filed on May 2, 2011, in the Korean Intellectual Property Office, the contents of which in its entirety are herein incorporated by reference.

### BACKGROUND

The inventive concept generally relates to data storage devices and to authentication apparatus for data storage devices. More particularly, the inventive concept relates to a hardware authentication apparatus that can be connected to a host device or an existing data storage device in order to prevent unauthorized copying of contents stored therein.

Many different types of data storage devices have been developed in recent years. Examples include memory cards equipped with flash memory, Universal Serial Bus (USB) memories that can connect into a USB port, and SSD (Solid State Device) memory that continues to gain popularity. One general trend is that data storage devices are being developed with increased storage capacity and decreased size. Another trend is that such devices are being developed with standardize interfaces which allow them to be detachably connected to a wide variety of different types of host devices. Thus, the portability of data storage devices is increasing. For example, in the case of a personal computer, a portable external hard drive of SSD memory may be used as a low-cost and flexible alternative to hard disc drive (HDD).

In the meantime, preventing unauthorized copying of digital content continues to present a challenge, which is made even more difficult by the portability of data storage devices. A number of different anti-copying techniques are known which are intended to allow only authorized users to reproduce digital content.

One anti-copying technology utilizes a data storage device having a built-in authentication function, which may be configured by a software module executed by an on-board microprocessor. For example, a Secure Digital (SD) card may have a password setting function for data security. As another example, a Secure Multimedia Card (MMC) has Digital Rights Management (DRM) capabilities for controlling how a file can be played such as the number of playbacks or playback time. Further, a technology related to an external hard drive having an authentication function has been presented in Korean Patent Laid-open Publication No. 10-2005-0095204.

### SUMMARY

The inventive concept provides an authentication method for performing authentication to determine whether to allow consumption of contents stored on a data storage device using a hardware authentication apparatus including a circuit that performs an authentication process, by connecting the authentication apparatus to one of a host device and the data storage device.

The inventive concept also provides a hardware authentication apparatus configured to add an authentication function for contents stored on a data storage device having no authentication function embedded therein during its production.

The inventive concept also provides a method for connecting a hardware authentication apparatus to a data storage device having no authentication function and a data storage device connected to the authentication apparatus so as to provide an authentication function.

The inventive concept also provides a host device connected to a data storage device or directly to a hardware authentication apparatus so as to perform an authentication process, which enables a user to consume contents stored on the data storage device.

These and other objects of the inventive concept will be described in or be apparent from the following description of the preferred embodiments.

According to an aspect of the inventive concept, there is provided an authentication apparatus which includes a data storage unit for storing authentication apparatus identification information, an interface unit for connecting to a host device through a first interface, and an authentication processor that executes an authentication process using the authentication apparatus identification information stored in the data storage unit. The authentication processor executes the authentication process upon receipt of an authentication request signal from the host device through the interface unit, and outputs an authentication response signal including data indicative of a result of the authentication process to the host device via the interface unit. The authentication request signal is for requesting authentication of a data storage device connected to the host device through a second interface.

According to another aspect of the inventive concept, there is provided a data storage device includes a bridge controller managing data transmission and reception to and from a host device through an interface, a memory unit including at least one of a non-volatile memory for storing a firmware and a random access memory (RAM) used to execute the firmware, and a large-capacity storage unit connected to the bridge controller and storing data contents. The memory unit is electrically connected to an authentication apparatus including an authentication processing circuit for performing an authentication process for consumption of the data contents.

According to still another aspect of the inventive concept, there is provided a data storage device a bridge controller managing data transmission and reception to and from a host device through a second interface, a memory unit including at least one of a non-volatile memory for storing a firmware and a random access memory (RAM) used in executing the firmware, and connecting to the bridge controller through a fourth interface, a large-capacity storage unit connected to the bridge controller through a third interface and storing data contents, and an authentication apparatus which is electrically connected as a separate module to the bridge controller through a first interface.

### BRIEF DESCRIPTION OF THE DRAWINGS

The above and other features and aspects of the inventive concept will become readily apparent from the detailed description that follows, with reference to the accompanying drawings, in which:

FIG. 1 illustrates a configuration of a data storage device connected to a host device according to a prior art arrangement;

FIG. 2 illustrates a configuration of a data storage device authentication system according to an embodiment of the inventive concept, in which an authentication apparatus is directly connected to a host device;

FIG. 3 illustrates a configuration of a data storage device authentication system according to an embodiment of the inventive concept in which an authentication apparatus is connected to a data storage device without utilizing a separate interface;

FIG. 4 illustrates a configuration of a data storage device authentication system according to another embodiment of the inventive concept, in which an authentication apparatus is connected to a data storage device without utilizing a separate interface;

FIG. 5 illustrates a configuration of a data storage device authentication system according to an embodiment of the inventive concept, in which an authentication apparatus is connected to a data storage device through a separate interface;

FIG. 6 illustrates a configuration of a data storage device authentication system according to another embodiment of the inventive concept, in which an authentication apparatus is connected to a data storage device via a separate interface; and

FIG. 7 illustrates a configuration of a data storage device authentication system according to another embodiment of the inventive concept, in which an authentication apparatus is connected to a data storage device through a separate interface.

### DETAILED DESCRIPTION OF THE EMBODIMENTS

Terms used herein are briefly described in order to aid in the understanding of the inventive concept. Thus, unless otherwise specified explicitly in this detailed description, it should be understood that the following definitions are not intended to limit the scope of the inventive concept.

“Content”

Content means data stored on a data storage device in a digital format, such as music, videos, documents, images, and computer programs.

“Content Consumption”

Content consumption means using content for its intended purpose. For example, when content is an image or document, content consumption may refer to displaying or printing the image or document. When content is music or video, content consumption may refer to playing back the music or video. When content is an application, content consumption may mean installing or executing the application.

“Host Device”

A host device is any device that can be connected to a data storage device and is configured to consume content of the data storage device. The host device may be a portable contents consuming device such as a mobile phone, a personal digital assistant (PDA), or an MP3 player, or stationary contents consuming device such as a desktop computer or a digital TV.

“Interface”

An interface refers to a physical link that connects one device to a connector or another device in order to support transmission and reception of data. The interface may be a universal data communication interface such as a Serial Peripheral Interface (SPI), a Universal Serial Bus (USB), an AT attachment (ATA) interface, a Serial ATA (SATA) interface, or an Integrated Drive Electronics (IDE) interface.

The inventive concept will now be described more fully hereinafter with reference to the accompanying drawings, in which preferred embodiments are shown. This inventive concept may, however, be embodied in different forms and should not be construed as limited to the embodiments set forth herein. Rather, these embodiments are provided so that this disclosure will be thorough and complete, and will fully convey the scope of the inventive concept to those skilled in the art. The same reference numbers indicate the same components throughout the specification and drawings.

Unless defined otherwise, all technical and scientific terms used herein have the same meaning as commonly understood by one of ordinary skill in the art to which this invention belongs. It is noted that the use of any and all examples, or exemplary terms provided herein is intended merely to better illuminate the invention and is not a limitation on the scope of the invention unless otherwise specified. Further, unless defined otherwise, all terms defined in generally used dictionaries may not be overly interpreted.

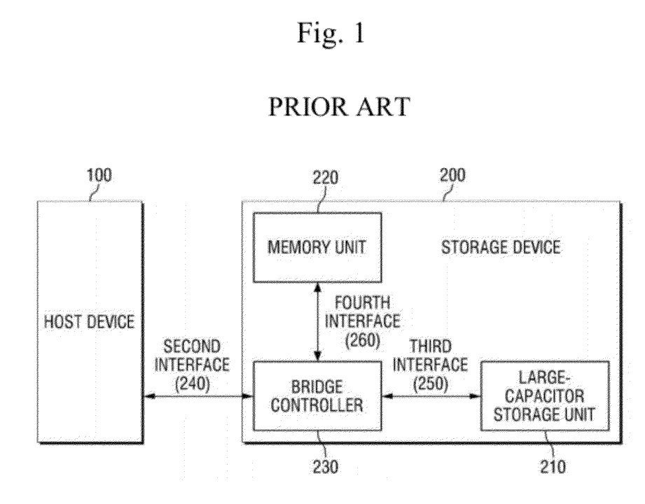

Prior to the discussion of the inventive concept, attention is first directed to FIG. 1 which illustrates a configuration of a data storage device 200 connected to a host device 100 according to a prior art configuration. Referring to FIG. 1, the data storage device 200 includes a large-capacity storage unit 210 for storing data, a memory unit 220, and a bridge controller 230.

For example, the large-capacity storage unit 210 contains non-volatile memory such as NAND-FLASH, NOR-FLASH, a hard disk drive, or Solid State Drive (SSD). The large-capacity storage unit 210 is connected to the bridge controller 230 through a third interface 250. The third interface 250 is a transmission/reception interface that supports input/output of data stored in the large-capacity storage unit 210. For example, the third interface 250 may be an ATA interface, a SATA interface, or an IDE interface. Content may be stored in the large-capacity storage unit 210.

The memory unit 220 may include at least one of a non-volatile memory for storing a firmware run during operation of the data storage device 200 and a random access memory (RAM) necessary for running the firmware on an operation unit within the data storage device 200. The memory unit 220 may be constructed by a NOR-FLASH module. The memory unit 220 connects to the bridge controller 230 through a fourth interface 260. The fourth interface 260 is a transmission/reception interface that supports input/output of data stored in the memory unit 220. For example, the fourth interface 260 may be a SPI.

The bridge controller 230 manages data transmission and reception between the host device 100 and the data storage device 200 through a second interface 240, and relays data transmission and reception between the large-capacity storage unit 210 and the host device 100. That is, the bridge controller 230 performs conversion between the second interface 240 that is an outside interface and the third and fourth interfaces 250 and 260 that are inside interfaces.

For example, the second interface 240 may be a USB, eSATA, FireWire (IEEE1394), or Bluetooth. The bridge controller 230 may perform a predetermined operation on data and run the firmware stored in the memory unit 220.

The data storage device 200 shown in FIG. 1 may be a USB memory, a memory card such as a Secure Digital (SD) card or a Multimedia Card (MMC), an external hard disk drive, or external Solid State Device (SSD). Examples of the data storage device 200 are a smart media card, a memory stick, a Compact Flash (CF) card, an Extreme Digital (XD) card, an MMC, a hard disk drive, an external hard drive, and an external SSD.

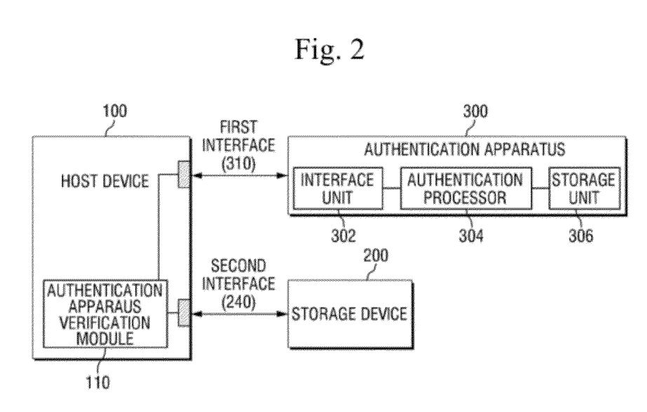

The configuration and operation of an authentication apparatus that can be connected to a host device, according to an embodiment of the inventive concept, will now be described with reference to FIG. 2. FIG. 2 illustrates a configuration of a data storage device authentication system according to an embodiment of the inventive concept in which an authentication apparatus 300 is directly connected to a host device 100.

Referring to FIG. 2, the authentication apparatus 300 of this example includes a storage unit 306 for storing authentication apparatus identification information (hereinafter referred to as “identification information”), an interface unit 302 connecting the authentication apparatus 300 to the host device 100 through a first interface 310, and an authentication processor 304 that performs an authentication process using the identification information according to an authentication request signal received through the interface unit 302. In addition, the authentication processor 304 outputs an authentication response signal containing the result of the authentication process to the host device 100 via the interface unit 302.

The authentication process is performed by the authentication processor 304 for consumption of contents stored in the data storage device 200. The authentication process begins when the authentication request signal received from the host device 100 through the interface unit 302 is input to the authentication processor 304.

The authentication request signal may include the identification information contained in the contents. The authentication process includes comparing the identification information stored in the storage unit 306 with the identification information in the authentication request signal, and producing the authentication result.

More specifically, the authentication apparatus 300 determines the success or failure of the authentication. For example, if the identification information contained in the contents matches the identification information stored in the storage unit 306, the authentication processor 304 determines that the authentication is successful. The authentication response signal may include data indicating the determined authentication result. Furthermore, according to the present embodiment, the authentication apparatus 300 includes one or more special purpose microchips or microprocessors designed to perform a predetermined operation. Thus, they are generally impervious to malicious reprogramming and/or design changes which would allow the authentication result to be altered. Overall security is thereby enhanced.

On the other hand, when the authentication apparatus 300 is configured to determine the success/failure of the authentication, an authentication apparatus may be hacked such that it always determines the authentication is successful. In this case, contents cannot be protected from unauthorized copying. In order to prevent such occurrences, the authentication process may include transmitting the identification information stored in the storage unit 306 to the host device 100 through the interface unit 302. The authentication result may be created by an authentication apparatus verification module 110 (hereinafter called the “verification module”) within the host device 100.

The authentication process may further include encrypting the identification information and providing the encrypted information to the host device 100. The authentication process may further include coding the identification information and providing the coded information to the host device 100. That is, the authentication response signal may include encrypted or coded identification information. The encryption or coding may prevent the identification information from being exposed to unauthorized users.

The storage unit 306 may include at least one of non-volatile memories such as Read Only Memory (ROM), Programmable ROM (PROM), Erasable PROM (EPROM), Electrically EPROM (EEPROM), and flash memory, but the inventive concept is not limited thereto.

The authentication processor 304 may include at least one operation unit for performing the authentication process. The operation unit may be a microprocessor or microchip.

The authentication processor 304 may be configured as an authentication processing circuit (not shown) for performing an authentication process using the identification information. Because the authentication processing circuit is designed only for the authentication process, it does not perform an operation related to input/output of data stored in the data storage device 200.

The interface unit 302 manages transmission and reception of data between the authentication apparatus 200 and the host device 100, and may include a connector (not shown) configured to be detachably electrically connected with the host device 100. In this case, after the authentication is completed for contents stored in one data storage device 200, the authentication apparatus can be detached from the host device 100 and then attached to another host device 100 in order to enable authentication for contents stored in another data storage device. Thus, a single authentication apparatus 300 may be used to allow consumption of contents stored in two or more data storage devices 200.

Referring to FIG. 2, the authentication apparatus 300 is connected to the host device 100 through the first interface 310 so as to transmit/receive data to/from the host device 100 through the first interface 310. The data storage device 200 is connected to the host device 100 through a second interface 240 so as to transmit/receive data through the second interface 240. As shown in FIG. 2, the first interface 310 is a different type from the second interface 240. Alternatively, the first interface 310 is the same type as the second interface 240. For example, the first and second interfaces 310 and 240 are both USB interfaces. The authentication apparatus 300 and the data storage device 200 may be connected to different USB ports of the host device 100.

Meanwhile, the first interface 310 may be a wireless communication interface. For example, the first interface 310 may be a short-range wireless interface such as a Bluetooth interface, a Near-Field Communication (NFC) interface, or a Radio Frequency Identification (RFID) interface. Use of the wireless communication interface can prevent unauthorized copying of contents while eliminating inconvenience of having to physically connecting to the host device 100. However, it may be desirable to avoid using a long-range wireless interface such as Internet interface or third-generation (3G) mobile communication interface. This is because use of a long-range wireless interface may enable authentication of an unlimited number of data storage devices 200 using a single authentication apparatus 300.

When the verification module 110 is not installed in the host device 110, the authentication apparatus 300 may further include a verification module installer (not shown) for installing the verification module 110. When a user of the host device 100 enters a command in order to consume contents stored in the data storage device 200, the verification module 110 performs an authentication process on a host device side.

The authentication process for the host device side may include the following operations.

First, authentication related information is extracted from contents, and identification information is obtained from the authentication related information.

Next, an authentication request signal is sent to the authentication apparatus 300 in order to verify whether the authentication apparatus 300 having the identification information stored therein is connected to the host device 100. The authentication request signal may include identification information contained in the contents.

Then, data contained in an authentication response signal, which is received from the authentication apparatus 300, is analyzed. When the authentication request signal includes the identification information contained in the contents, the authentication response signal may include data indicating the success/failure of the authentication. In this case, the result of the analysis may be used to determine whether to allow consumption of the contents. If the contents is encrypted, the contents may be decrypted to its original form.

On the other hand, when the authentication response signal includes identification information stored in the authentication apparatus 300, the contents is decrypted using the identification information in order to determine whether to allow consumption of the contents.

The verification module 110 may be an operation unit which is installed in the host device 100 and performs an authentication process on the host device side. When the host device 100 does not have the verification module 110 installed therein, the verification module installer sends verification module installation data stored in the storage unit 306 to the host device 110 in order to install the verification module 110 in the host device 100.

In this case, the verification module 110 may be installed in the host device 100 without separate manipulation by a user of the host device 100, simply by connecting the authentication apparatus 300 to the host device 100.

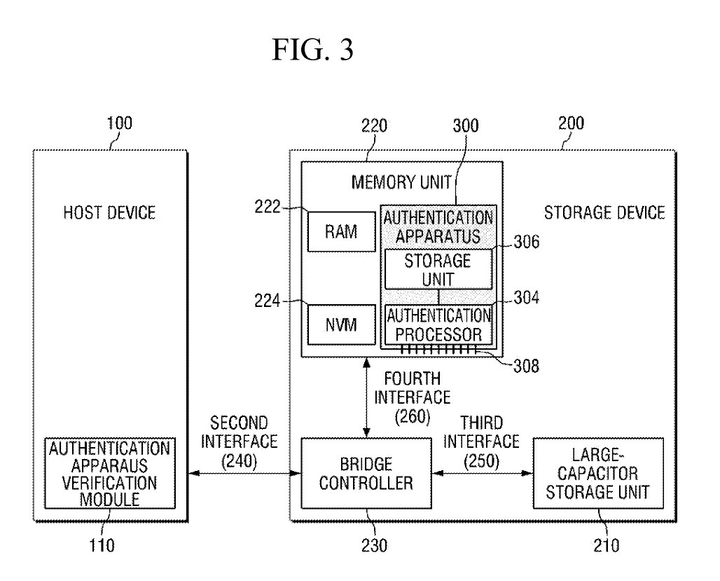

Data storage device authentication systems according to embodiments of the inventive concept in which the authentication apparatus 300 is connected to the data storage device 200 will now be described in detail with reference to FIGS. 3 through 7. When the authentication apparatus 300 is directly connected to the host device 100, the authentication apparatus 300 is physically separated from the data storage device 200. Aside from unauthorized copying of the contents, users may not be allowed to consume contents if they do not have the authentication apparatus 300. Such inconvenience can be eliminated by connecting the authentication apparatus 300 to the data storage device 200.

This may also prevent the use of hacked authentication apparatus that always produces a successful authentication. When the authentication apparatus 300 is connected to a module within the data storage device 200, unauthorized users have to disassemble the inside of the data storage device 200 in order to replace the normal authentication apparatus 300 with the hacked one. Thus, the use of hacked authentication apparatus can be suppressed.

The authentication apparatus 300 may be connected to the data storage device 200 by electrically connecting with at least some of modules in the data storage device 200. The authentication apparatus 300 may include an authentication processing circuit (not shown). The authentication processing circuit may be electrically connected to at least some of the modules in the data storage device 200 and perform an authentication process using the identification information that is unique to the authentication apparatus 300. The identification information may be stored in a storage unit within the authentication processing circuit.

In response to an authentication request signal, the authentication processing circuit performs an authentication process using the identification information and outputs an authentication response signal carrying data related to the authentication result. As described above, the authentication response signal may include the data related to the authentication result or data related to identification information.

The authentication processing circuit may be designed to only perform the authentication process upon receipt of the authentication request signal, and output the authentication response signal including the result of the authentication process. When the authentication process is implemented at a circuit level (instead of using software), the authentication process is performed according to the operation of each element in a circuit. Thus, in this case, it is essentially not possible to change the authentication process through unauthorized software-based hacking, without physically changing the element in the circuit. This configuration may eliminate the need for a separate space in which firmware for performing the authentication process is stored.

The authentication processing circuit may include at least one operation unit such as a microchip or microprocessor. The authentication apparatus 300 may be connected to the memory unit 220 of the data storage device 200 or the large-capacity storage unit 210.

The authentication apparatus 300 may be electrically connected to a module in the data storage device 200 only for transmission/reception of an authentication-related signal from/to the host device 100. That is, the authentication apparatus 300 does not perform an operation related to input/output of data stored in the large-capacity storage unit 210.

An authentication system in which an authentication apparatus 300 is connected to a memory unit 220 in a data storage device 200 according to an embodiment of the inventive concept is described in detail with reference to FIG. 3.

The authentication apparatus 300 shown in FIG. 3 includes a storage unit 306 for storing identification information, a coupler 308 providing an electrical coupling to a data storage device without an authentication unit, and an authentication processor 304 that performs an authentication process using the identification information according to an authentication request signal received through the coupler 308, and outputs an authentication response signal carrying data related to the authentication result.

Referring to FIG. 3, the memory unit 220 in the data storage device 200 may include a non-volatile memory (NVM) 224 for storing firmware executed during operation of the data storage device 200 and a RAM 224. It should be understood that the authentication apparatus 300 is not a program stored in the NVM 224, but instead is a hardware apparatus connected into a module in the memory unit 220 through an electrical coupling, which transmits/receives data to/from a bridge controller 230 through a fourth interface 260. For example, the authentication processing circuit may be mounted to a substrate of the module in the memory unit 220 so that the authentication apparatus 300 transmits/receives data to/from the host device 100 via the bridge controller 230 using the fourth and second interfaces 260 and 240. Alternatively, the authentication processing circuit may be embedded in the substrate of a module in the memory unit 220.

The coupler 308 provides an electrical coupling between the authentication apparatus 300 and the memory unit 220. The coupler 308 connects the authentication apparatus 300 to a portion of the memory unit 220 connected to the fourth interface 260 so that a signal input to the authentication apparatus 300 is delivered to the authentication processor 304 and a signal produced by the authentication processor 304 is transmitted to the bridge controller 230 and the host device 100 through the fourth and second interfaces 260 and 240, respectively.

Upon receipt of an authentication request signal for consumption of contents, the authentication processor 304 from a verification module 110 through the bridge controller 230, the authentication processor 304 performs the authentication process.

The authentication request signal may include the identification information contained in the contents. The authentication process includes comparing the identification information stored in the storage unit 306 with the identification information in the authentication request signal and producing the authentication result.

More specifically, if the identification information contained in the contents is the same as the identification information stored in the storage unit 306, the authentication processor 304 determines that the authentication is successful. The authentication response signal carrying data related to the authentication result is output through the coupler 308.

The authentication process may further include encrypting the identification information and providing the encrypted information to the host device 100. In this case, the authentication response signal carrying the encrypted identification information is output through the coupler 308.

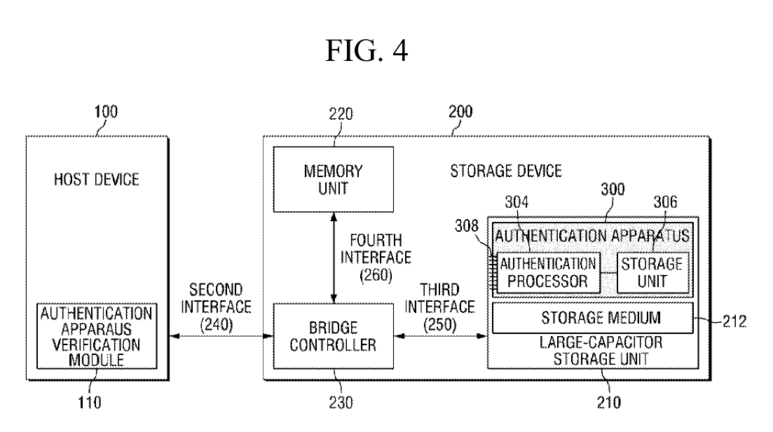

Next, an authentication system in which an authentication apparatus 300 is connected to a large-capacity storage unit 210 is described in detail with reference to FIG. 4. When the authentication apparatus 300 is connected to the large-capacity storage unit 210, it should be understood that the authentication apparatus 300 is not a program stored in a storage medium 212, but instead is a hardware apparatus connected into the large-capacity storage unit 210 through an electrical coupling, which transmits/receives data to/from a bridge controller 230 through a third interface 250. For example, the authentication processing circuit may be mounted to a substrate within the large-capacity storage unit 210 so that the authentication apparatus 300 transmits/receives data to/from a host device 100 via the bridge controller 230 using the third and second interfaces 250 and 240. Alternatively, the authentication processing circuit may be embedded in the substrate within the large-capacity storage unit 210. Thus, the authentication apparatus 300 transmits/receive data from/to the host device 100 through the bridge controller 230 using the third and second interfaces 250 and 240. Because the operation and configuration of the authentication processor 304, the storage unit 306, and a coupler 308 are substantially the same as those of the counterparts in the authentication apparatus 300 shown in FIG. 3, their detailed descriptions are omitted.

In one embodiment, the authentication apparatus 300 may be installed as a new module of the data storage device 200 and connected to the data storage device 200 through a specific interface. The interface between the authentication apparatus 300 and the data storage device 200 may be an interface that is or not used within the data storage device 200. The interface that is used within the data storage device 200 may be the third or fourth interface 250 or 260 shown in FIG. 1.

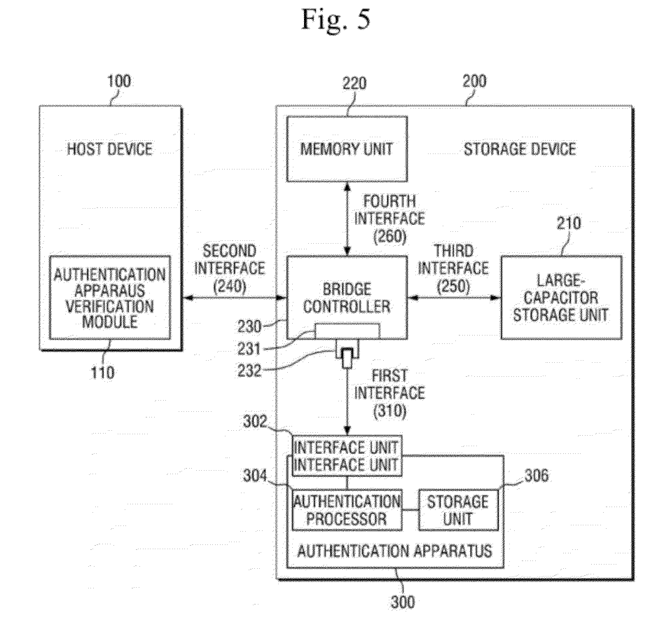

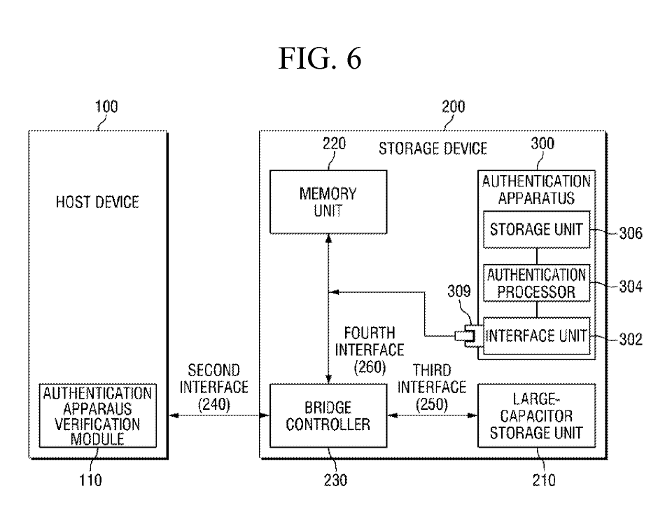

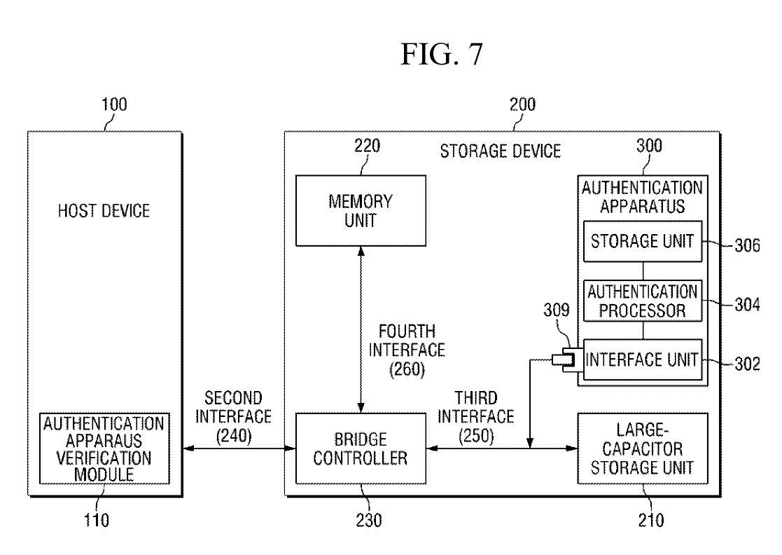

A data storage device authentication system in which an authentication apparatus 300 is installed as a new module of a data storage device 200 and connected to the data storage device 200 via a specific interface is described in detail with reference to FIGS. 5 through 7. FIG. 5 illustrates a data storage device authentication system configured to connect the authentication apparatus 300 to a data storage device 200 through an interface that is not used within the data storage device 200, according to an embodiment of the inventive concept. FIG. 6 illustrates a data storage device authentication system according to another embodiment of the inventive concept, in which an authentication apparatus 300 is connected to a data storage device 200 via the same type of interface as the fourth interface 260 that is used within the data storage device 200. FIG. 7 illustrates a data storage device authentication system according to another embodiment of the inventive concept, in which a data storage device 200 is connected to a bridge controller 230 via the same type of interface as the third interface 250 that is used within the data storage device 200. The authentication apparatus 300 may be installed during or after production of the data storage device 200. If it is installed after the production, a connector for installing the authentication apparatus 300 may be provided so as to facilitate user's installation, which will be described in more detail below.

First, a data storage device authentication system configured to connect the authentication apparatus 300 to the data storage device 200 through a different type of interface from an interface that is used in the data storage device 200 is described with reference to FIG. 5.

The configuration and operation of the authentication apparatus 300 shown in FIG. 5 will now be described. The authentication apparatus 300 includes a storage unit 306 for storing authentication apparatus identification information (“identification information”), an interface unit 302 connecting the authentication apparatus 300 to a bridge controller 230 through a first interface 310, and an authentication processor 304 that performs an authentication process using the identification information according to an authentication request signal received through the interface unit 302.

Because the authentication processor 304 and the storage unit 306 have the same configurations and functions as their counterparts shown in FIGS. 2 through 4, a detailed description thereof is omitted.

The interface unit 302 is different from the coupler 308 of the authentication apparatus 300 shown in FIGS. 3 and 4 in that it uses a universal interface having a predefined communication protocol format to directly connect to the bridge controller 230.

The interface unit 302 may connect the authentication apparatus 300 to the data storage device 200 through the first interface 310 that is a different type from an interface used for input/output of data stored in the data storage device 200. When the authentication apparatus 300 is connected to a module within the data storage device 200, because the data storage device 200 does not support the first interface, a module for supporting the first interface 310 may be added to the module within the data storage device 200 connected to the authentication apparatus. Referring to FIG. 5 in which the authentication apparatus 300 is connected to the bridge controller 230, a first interface support module 231 for supporting the first interface 310 is installed additionally to the bridge controller 230.

The first interface support module 231 supports input/output of data using the first interface 310. The first interface support module 231 may include a connector 232 configured to be detachably connected with the authentication apparatus 300. Installation of the first interface support module 231 in the module within the data storage device 200 and the connector 232 in the first interface support module 231 facilitate the attachment and detachment of the authentication apparatus 300. That is, this configuration allows consumers of the data storage device 200 to attach or detach the authentication apparatus after release of the data storage device 200.

The interface unit 302 may connect the authentication apparatus 300 to the data storage device 200 through the first interface 310 that is the same type as at least one of interfaces used for input/output of data stored in the data storage device 200. This configuration eliminates the need for install a separate interface support module for connecting the authentication apparatus 300 in the data storage device 200.

Data storage device authentication systems configured to connect the authentication apparatus 300 to the data storage device 200 through an interface that is the same type as an interface used in the data storage device 200 will now be described with reference to FIGS. 6 and 7.

Referring to FIG. 6, the interface unit 302 connects the authentication apparatus 300 to the bridge controller 230 through the same type of interface as the fourth interface 260. In this case, the authentication apparatus 300 may further include a connector 309 for supporting the fourth interface 260. For example, the fourth interface 260 may be a SPI. The connector 309 may have a coupling member that is configured to easily connect or disconnect a cable having the same format as the fourth interface 260 to or from the interface unit 302.

Referring to FIG. 7, the interface unit 302 may connect the authentication apparatus 300 to the bridge controller 230 through the same type of interface as the third interface 250. In this case, the authentication apparatus 300 may further include a connector 309 for supporting the third interface 250. The connector 309 may have a coupling member that is configured to easily connect or disconnect a cable having the same format as the third interface 250 to or from the interface unit 302.

While the inventive concept has been particularly shown and described with reference to exemplary embodiments thereof, it will be understood by those of ordinary skill in the art that various changes in form and details may be made therein without departing from the spirit and scope of the inventive concept as defined by the following claims. It is therefore desired that the present embodiments be considered in all respects as illustrative and not restrictive, reference being made to the appended claims rather than the foregoing description to indicate the scope of the invention.

What is claimed is:

1. An authentication apparatus comprising:
a data storage unit for storing authentication apparatus identification information;
an interface unit for connecting to a host device through a first interface; and
an authentication processor that executes an authentication process using the authentication apparatus identification information stored in the data storage unit, the authentication processor executing the authentication process upon receipt of an authentication request signal from the host device through the interface unit, and outputting an authentication response signal including data indicative of a result of the authentication process to the host device via the interface unit, wherein the authentication request signal is for requesting authentication of a data storage device connected to the host device through a second interface.

2. The authentication apparatus of claim 1, wherein the authentication request signal is received in response to an attempt to consume contents stored in the data storage device.

3. The authentication apparatus of claim 1, wherein the interface unit includes a connector configured to be detachably connected with the host device.

4. The authentication apparatus of claim 1, wherein the storage unit additionally stores authentication apparatus verification module installation data, the authentication apparatus further comprising a verification module installer that transmits the authentication apparatus verification module installation data to the host device when connecting to a host device.

5. A data storage device comprising:
a bridge controller managing data transmission and reception to and from a host device through an interface;
a memory unit including at least one of a non-volatile memory for storing a firmware and a random access memory (RAM) used to execute the firmware, and connected to the bridge controller; and
a large-capacity storage unit connected to the bridge controller and storing data contents,
wherein the memory unit is electrically connected to an authentication apparatus including an authentication processing circuit for performing an authentication process for consumption of the data contents.

6. The data storage device of claim 5, wherein the memory unit provides an authentication request signal received from the host device through the bridge controller to the authentication apparatus, and transmits an authentication response signal output from the authentication apparatus to the host device through the bridge controller.

7. The data storage device of claim 6, wherein the authentication request signal includes data related to authentication apparatus identification information obtained from the data contents.

8. The data storage device of claim 7, wherein the authentication response signal includes data related to a result of the authentication process obtained by comparing the authentication apparatus identification information extracted from the data contents with the authentication apparatus identification information stored in the authentication apparatus.

9. The data storage device of claim 6, wherein the authentication response signal includes data related to the authentication apparatus identification information.

10. The data storage device of claim 9, wherein the authentication response signal includes data related to encrypted authentication apparatus identification information.

11. A data storage device comprising:
a bridge controller managing data transmission and reception to and from a host device through a second interface;
a memory unit including at least one of a non-volatile memory for storing a firmware and a random access memory (RAM) used in executing the firmware, and connecting to the bridge controller through a fourth interface;
a large-capacity storage unit connected to the bridge controller through a third interface and storing data contents; and
an authentication apparatus which is electrically connected as a separate module to the bridge controller through a first interface.

12. The data storage device of claim 11, wherein the first interface is a different type of interface than the second through fourth interfaces.

13. The data storage device of claim 12, wherein the bridge controller includes an interface support module.

14. The data storage device of claim 13, wherein the interface support module includes a connector that allows the authentication apparatus to be detachably and electrically connected.

15. The data storage device of claim 11, wherein the first interface is a same type as the third interface, and the authentication apparatus includes a connector supporting the third interface.

16. The data storage device of claim 11, wherein the first interface is a same type as the fourth interface, and the authentication apparatus includes a connector for supporting the fourth interface.

17. The data storage device of claim 11, wherein the authentication apparatus includes:
a data storage unit for storing authentication apparatus identification information; and
an authentication processor that executes an authentication process using the authentication apparatus identification information stored in the data storage unit.

18. The data storage device of claim 17, wherein the authentication processor executes the authentication process upon receipt of an authentication request signal from the host device through the bridge controller, and outputs an authentication response signal including data indicative of a result of the authentication process to the host device via the bridge controller.

19. The authentication apparatus of claim 18, wherein the authentication request signal is received in response to an attempt to consume the data contents stored in the large-capacity storage unit.

20. The authentication apparatus of claim 17, wherein bridge controller includes an interface support module, and the interface support module includes a connector that allows the authentication apparatus to be detachably and electrically connected to the bridge controller.
